(19) United States
(12) Patent Application Publication
(10) Pub. No.: US 2021/0114247 A1
(43) Pub. Date: Apr. 22, 2021

(54) Punching Sheet for Punching Tags or Labels, and Process for Manufacturing Same

(71) Applicant: WINK Stanzwerkzeuge GmbH & Co. KG, Neuenhaus (DE)

(72) Inventor: Albertus de Natris, Nordhorn (DE)

(21) Appl. No.: 16/497,455

(22) PCT Filed: Mar. 13, 2018
(86) PCT No.: PCT/EP2018/056271

§ 371 Date: Sep. 25, 2019

(30) Foreign Application Priority Data
Mar. 29, 2017 (DE) 10 2017 106 780.9

(51) Int. Cl. B26F 1/44; B26F 1/20

(52) U.S. Cl. CPC B26F 1/44; B26F 2001/4409; B26F 1/20

(57) ABSTRACT

Disclosed is a punching sheet for punching tags or labels, comprising a main sheet (2), on the top face of which at least one punching line (4) is provided, and in at least some areas of a bottom face (3) of which at least one damping element (14) is arranged. Also disclosed is a process for manufacturing a punching sheet.

The present invention concerns a punching sheet for punching tags or labels, with a base sheet provided on its top face with at least one punching line. Moreover, the invention concerns a method for producing such a punching sheet.

For rotary punching of tags, punching sheets with height tolerances as small as possible are required and produced. The latter are within a range of +/−2 to +/−5 micrometers (μm). The requirement regarding the precision of the punching sheets as well as the machines or cylinders, on which these punching sheets are attached for punching tags or labels, rise even more strongly for the materials to be punched that are employed nowadays and provided with PET carriers or with film monomaterials.

Punching or magnet cylinders and counterpart punching cylinders comprise moreover a true running tolerance of, for example, about 5 μm. The latter as well as the tolerances of the punching sheet lead to worse punching results when the punching lines with their punching edges, due to the spacing of the cylinders relative to each other, cannot penetrate far enough into the material to be punched.

On the other hand, when punching and counterpunching cylinders are closed too far so that the spacing of the two cylinders becomes too small, the punching edges or cutting edges may become damaged when they punch through the material to be punched and the carrier material layer and impact too strongly on the counterpart punching or counter pressure cylinder.

When punching primarily film tags on polyester carrier materials or PET layers, even smaller tolerances are required because the hard, non-compressible PET plastic material forgives only minimal deviations. The risk of damage to the PET carrier is significantly greater and cutting through the carrier due to imprecise adjustment causes significant problems in the production.

In particular when producing in-mould labels that are comprised of a plurality of very thin layers of comparative hard film, the aforementioned problems occur. In-mould labels are punched out; thus, a punching-through application is concerned. When closing too far, the punching sheet as described will become rolled flat, the cutting edges of the punching lines become blunt. In this way, the service life of the punching sheets is significantly reduced.

It is therefore object of the present invention to extend the service life of punching sheets for the described applications.

This object is solved by subject matter according to claim 1 as well as a method according to claim 9.

Advantageous embodiments of the invention can be taken from the dependent claims depending from these claims as well as the following description.

The punching sheet according to the invention for punching tags or labels, in particular in-mould labels, wherein the punching sheet comprises a base sheet provided at its top face with at least one punching line, is characterized in that at a bottom face of the base sheet, at least in sections, at least one damping element is arranged. This damping element reduces, due to its damping properties, the forces acting on a cutting edge or edge of a punching line during “hard-on-hard” punching. In this way, tolerances can be compensated and is possible for the first time with reliable processing to punch tags on very thin polyethylene terephthalate carrier materials with thicknesses of 12 micrometers. The damping element can then be adjusted such that the layers that are to be punched are punched but, upon impacting on the harder carrier layer, the damping element is compressed. Tolerances of the punching device and of the punching sheet can thus be compensated.

The damping element can be attached to the bottom face of the base sheet as a type of an exchange sleeve, i.e., secured detachably. It is however advantageous to use a damping element which is fixedly connected to the bottom face of the base sheet so that flexing movements during punching are reduced.

Preferably, the damping element, viewed in a plan view onto the punching sheet, is arranged below the punching line or punching lines so that the forces acting on the punching line or several provided punching lines can be optimally dampened. In particular, the one or several damping elements are arranged completely below the punching line(s).

For simplified production, the damping element can be embodied areally, at least in sections. This reduces further the risk of flexing of the punching sheet during operation, in particular when the damping element is attached correspondingly areally to the bottom face of the base sheet.

A particularly simple, but at the same time effective embodiment of the invention is provided when the damping element is embodied as a single-layer or multi-layer back face coating. In this regard, an areal and reliable contact of the punching sheet on the magnet cylinder or the punching cylinder is realized also. The back face coating covers the bottom face of the punching sheet across large portions and in particular completely and is in particular provided where the base sheet during punching absorbs forces from the punching line or punching lines.

Tolerances that are existing during punching can change during the duration of the punching process as well as across the surface of the punching sheet. The damping element is therefore preferably compressible and in particular elastically deformable so that the punching sheet can adapt to the locally and temporarily existing tolerances and compensate them. While fixedly existing tolerances can be compensated in case of an only compressible embodiment of the damping element, the application range can be significantly increased in case of an embodiment of the damping element as an elastically deformable single-layer or multi-layer back face coating. Also, by means of such a damping element which, in sections, is compressible to different degrees, the heights of punching edges located at different height levels above the base sheet can be compensated during punching.

The damping element is adjusted with respect to its elasticity such that the penetration of the cutting edge into the material to be punched and thus the actual punching process does not suffer; but a compression is realized substantially only when punching is done hard on hard. This applies independent of the fact that in particular the material of the damping element can be already minimally compressed when the punching edge impacts on material to be punched.

As damping element, one is in particular conceivable that is at least partially embodied of plastic material, in particular of PTFE. Particularly suitable is a layer of PTFE which is applied onto the back face or bottom face of the base sheet and which is well suited for the materials which are currently employed for in-mould labels. Alternatively or in addition, parts of the damping element can also be embodied of a natural material, in particular rubber.

It is understood that the application of the damping element to the bottom face of the base sheet can be realized with the aid of adhesive agents. For example, the base sheet can be primed, as needed, in order to attach a damping element, in particular an areal damping element.

By means of extensive experiments, it was found that the damping element should have a thickness between 4 and 200 micrometers. The base sheet could thus be almost doubled with regard to its thickness. However, by use of the damping element, the base sheet can now be even reduced in regard to its thickness because the forces which are acting on the base sheet are dampened and therefore the base sheet can be embodied less stable. Therefore, in sum, further cost savings are possible in regard to the comparatively expensive base sheet. Preferably, the damping element has at least a thickness that corresponds to the sum of the tolerances to be expected of the total system.

When using presently leading systems, the layer thickness of a damping layer material or the thickness of a damping element in the direction perpendicular to the surface of the base sheet thus amounts to preferably at least 12 micrometers.

The aforementioned object is solved also by a method for producing a punching sheet in which the damping element is applied prior to sharpening the punching lines and the punching lines are sharpened subsequently. The tolerances of approximately +/−2 μm which are then produced by sharpening or engraving of the punching lines, also referred to as cutting lines, are then, in addition to the tolerances of the cylinders, the only ones that affect the punching result. The base sheet which is typically made of steel is coated on the back face for producing a damping element at the latest after etching. For producing the coating, preferably a spraying method is employed.

According to a further embodiment of the invention, it can be advantageous when the damping element is applied already prior to an exposure of the punching sheet blank so that the punching sheet is additionally protected during the etching process.

By spraying on the damping element in particular in the form of a back-face coating of the base sheet of a punching sheet, already a precise application of the layer thicknesses is ensured. By the subsequent sharpening, disadvantages due to still possibly existing contaminations or thicker portions of the damping element are reduced ultimately. By adjusting the elasticity of the material to the material to be punched, not only the service life of the punching sheet is increased but also material that is even thinner can be punched even more precisely.

Further advantages and details of the invention can be taken from the following figure description. It is shown, schematically illustrated, in:

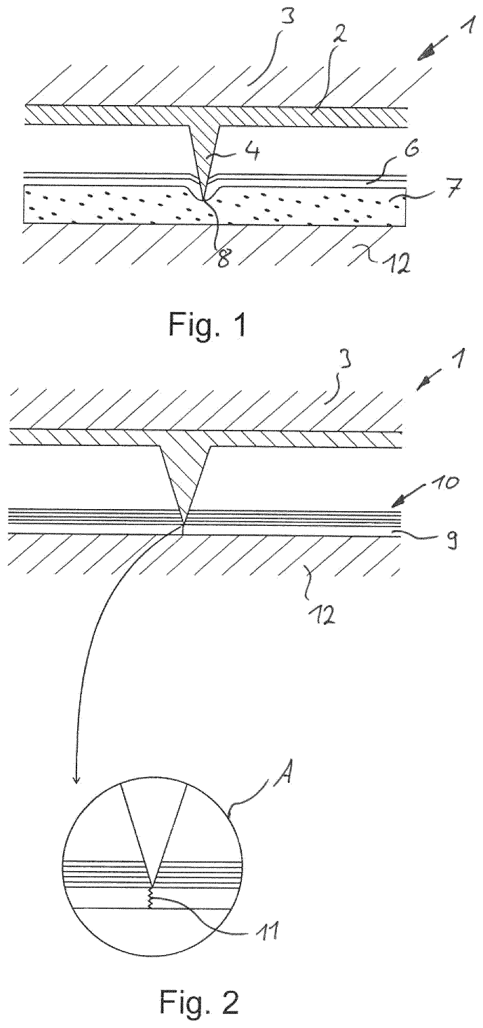

FIG. 1 a device according to the prior art;

FIG. 2 a further example of the prior art;

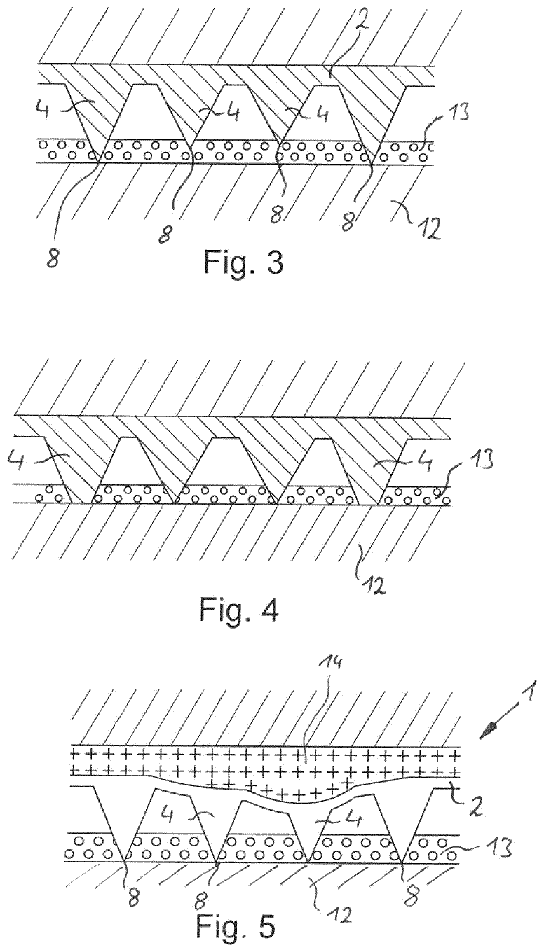

FIGS. 3 and 4 further prior art;

FIG. 5 an article according to the invention.

Individual technical features of the embodiments described in the following can also be combined, in combination with the afore described embodiments as well as the features of the independent claims and possible further claims, to subject matter according to the invention. If meaningful, elements that are functionally acting the same are provided with identical reference characters.

According to an embodiment of the prior art, a punching sheet 1 comprises a base sheet 2 that in FIG. 1 is oriented with its top face facing downwardly. In FIG. 1, a bottom or back face 3 is illustrated facing up. At the top face, a punching line 4 is arranged. The latter punches a two-layer tag material 6 which is arranged on a carrier material 7. Visible is the compression of the carrier material 7 in which a bottom edge 8 of the punching line remains substantially intact.

A further punching process according to the prior art is disclosed in FIG. 2. Here, a punching sheet 1 of in principle identical configuration punches a material web for producing in-mould labels. They are constructed of a multi-layer in-mould label material 10 wherein here a lower web 9 is illustrated thicker in relation to the further layers of the in-mould label material 10. This material 10 is to be punched through with exception of the layer 9. The last film layer 9 is meant to rupture due to the punching pressure which is illustrated by the zigzag line 11 in the enlarged illustration A of FIG. 2. It is attempted to avoid punching through in order to prevent the punching edge from impacting on a counterpart punching cylinder 12 and to thereby increase the service life of the punching sheet.

In FIGS. 3 and 4, two further scenarios of the prior art are illustrated. Both are disadvantageous. The punching sheet 1 illustrated in FIG. 3 comprises cutting edges 8, some of which have a different spacing from the base sheet 2. The cutting or punching lines 4 have a different height. These differences result in particular from tolerances during engraving of the punching lines 4.

While the two outer punching edges 8, in FIG. 3 to the left and to the right, punch all the way through to a counterpart punching cylinder 12 and in this context remain however free of any damage, the two central punching edges 4 are more flat and incompletely punch the material 13 to be punched. In the case that due to these tolerances the spacing between magnet or punching cylinder and counterpart punching cylinder 12 are reduced, the outer punching lines become greatly blunt because they impact too strongly on the counterpart punching cylinder 12. The material to be punched is squeezed and no longer punched. The punching result is unsatisfactory, as in case of FIG. 3.

According to the invention, it is provided that an elastically deformable damping material 14 in the form of a back face layer or coating of the base sheet 2 is provided (FIG. 5). The two taller outer punching edges 8 impact earlier on the counter part punching cylinder 12 than the punching lines at the center which are less tall (in FIG. 5, the two central punching lines 4). However, the layer which is arranged on the bottom face of the base sheet 2 is now compressed so that the punching edges 8 of the two central punching lines 4, where the region of the damping element 14 provided at the back face is not compressed or only less strongly compressed, can punch also. The module of elasticity of the back face coating is adjusted such that the punching edges 8 punch the material 13 to be punched but, upon impacting on the punching cylinder 12, the damping element 14 is compressed prior to the the outer punching edges 8 becoming damaged. The punching sheet 1 can thus be employed for a long period of time.

What is claimed is:

1.-11. (canceled)

12. A punching sheet for punching tags or labels, the punching sheet comprising:
a base sheet comprising a top face and a bottom face opposite the top face;
at least one punching line arranged on the top face;
at least one damping element arranged on the bottom face at least in sections of the bottom face.

13. The punching sheet according to claim 12, wherein the at least one damping element, viewed in a plan view of the punching sheet, is arranged below the at least one punching line.

14. The punching sheet according to claim 12, wherein the at least one damping element is areally embodied, at least over sections.

15. The punching sheet according to claim 12, wherein the at least one damping element is embodied as a single-layer back face coating or a multi-layer back face coating.

16. The punching sheet according to claim 12, wherein the at least one damping element is compressible.

17. The punching sheet according to claim 16, wherein the at least one damping element is elastically deformable.

18. The punching sheet according to claim 12, wherein the at least one damping element is embodied at least partially of plastic material.

19. The punching sheet according to claim 18, wherein the plastic material is PTFE (polytetrafluoroethylene).

20. The punching sheet according to claim 12, wherein the at least one damping element is embodied at least partially of a natural material.

21. The punching sheet according to claim 20, wherein the natural material is rubber.

22. The punching sheet according to claim 12, wherein the at least one damping element comprises a thickness between 4 micrometers and 200 micrometers.

23. A method for producing a punching sheet according to claim 12, wherein the method comprises:
applying the at least one damping element prior to sharpening of the at least one punching line; and
subsequently, sharpening the at least one punching line.

24. The method according to claim 23, wherein, in the step of applying, the at least one damping element is applied to a punching sheet blank, the method further comprising exposing the punching sheet blank subsequent to the step of applying the at least one damping element.

25. The method according to claim 23, wherein, in the step of applying, the at least one damping element is applied by a spray-on method.
